(19) United States
(12) Patent Application Publication
(10) Pub. No.: US 2005/0181221 A1
(43) Pub. Date: Aug. 18, 2005

(54) Electronically conductive spacers, method for making same and uses in particular for display screens

(75) Inventors: Dorothee Martin, Suresnes (FR); Didier Jousse, Taverny (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 10/509,322

(22) PCT Filed: Apr. 8, 2003
(86) PCT No.: PCT/FR03/01108

(30) Foreign Application Priority Data
Apr. 8, 2002 (FR) 02/04378

(51) Int. Cl. B32B 19/00; B32B 15/00; B32B 17/06; B32B 9/00; H01J 19/42

(52) U.S. Cl. 428/432; 428/426; 428/701; 428/702; 427/248.1; 313/292

(57) ABSTRACT

A spacer for keeping a space between two substrates formed from glass sheets, more particularly a space of small thickness, generally less than a few millimeters, over the entire area of the sheet substrates, in a device such as a display screen, vacuum-type insulating glazing or a flat lamp, the surface of said spacer being at least partly electronically conducting, characterized in that said spacer is formed from a core not exhibiting electronic conductivity, the shape and the constituent material of which are chosen to provide the thermomechanical integrity of the substrates in the final device, said core being at least partly coated with at least one layer of a glass exhibiting electronic conductivity, and capable of giving the spacer electronic conductivity at 50° C. of 10⁻¹³ to 10 ohm⁻¹.cm⁻¹.

The present invention relates to spacers for keeping two substrates, formed by sheets of a material such as glass, spaced apart.

Although the invention is not limited to such applications, it will be more particularly described with reference to spacers used for keeping a space between two glass sheets, more particularly a space of small thickness, generally less than one millimeter or a few millimeters, over the entire area of the glass sheets.

Such a configuration is widely sought after for the production of display screens, whatever the technology; these are, for example, plasma screens, field emission displays (FED), such as microtip screens, electroluminescence screens, etc.

Such a configuration may also be desirable for the production of vacuum-type insulating glazing or of flat lamps, such devices comprising at least two glass sheets, at least one spacing having to be maintained between two adjacent sheets. The expression “flat lamps” should be understood as encompassing lamps that may have a curvature over at least part of their surface, whatever the technology of these lamps however.

In the aforementioned screens or other devices, it is imperative for at least the external glass sheets or other external substrates, that is to say those that may be seen by an observer, to exhibit high optical transparency. The spacers must consequently be the least visible possible.

It is also necessary during the use of the display screens that the locations of the spacers do not become visible by the appearance either of bright areas or of dark areas around said spacers. In the specific case of display screens, this phenomenon of course disturbs the quality of the image and cannot therefore be tolerated. This brightening and/or darkening phenomenon around the spacers is already known and explained. This phenomenon is due in fact to the injection of charges at a spacer because of the secondary emission coefficient of the material, defined by the ratio of the number of secondary electrons reemitted to the number of primary electrons received; a coefficient different from 1 results in a local charging effect, which, depending on whether it is positive or negative, results in a brightening or darkening effect owing to the deviation of the path of the electrons.

Various types of spacer are known in the art: a first known type of spacer is a glass spacer, especially in the form of beads or cylinders polished so as to be the least visible possible.

It is also known to produce glass spacers of the fiber type, having a rectangular-type cross section.

Spacers that are improved over the latter are known from European patent application EP-A-0 627 389, which discloses a process for manufacturing glass polyhedra of polygonal cross section, in which a preform bar of polygonal cross section, advantageously polished on all its lateral faces, is drawn, the drawn bar is cut into several rods, these rods are joined together parallel to one another in such a way that they are properly held, they are cut to the desired length, the ends of the rods are all polished together, and they are separated from one another. In particular, this process is used to manufacture glass polyhedra possessing a cross section approximately of the polygonal type, the dimensions of the sides of which are less than one millimeter and the angles of the polygon of which are rounded with a radius of curvature of less than 10 microns.

U.S. Pat. No. 5,675,212 proposes spacers not made of glass, which is deemed to be not strong enough, but made of ceramic. One particular embodiment consists of ceramic spacers composed of an electrically insulating core and an electrically conducting coating layer formed from ceramic comprising oxides of transition metals such as Cr, Ti, Fe and V.

International application WO 99/56302 discloses glass spacers of polygonal shape that can be positioned accurately without encroaching on the “pixel” regions of the screens. Moreover, one means is also disclosed in that document for preventing the image from being disturbed near the spacer by bright areas or dark areas in a display screen, for example a plasma or field emission display (FED) type display screen: to prevent charges from building up through the spacer, and thus avoid the risk of a “breakdown” effect (a phenomenon described on page 8, lines 3 to 15 of WO 99/56302), the spacer may have, at least partly, a surface exhibiting electronic conduction. The electronic conduction is conferred by a conductive coating, which may be produced from amorphous silicon, which may or may not be doped with boron, phosphorus, arsenic or antimony deposited by chemical vapor deposition (CVD), or from conducting elements (silver, gold, copper), but which is made to migrate on the surface by applying a heat treatment or an ion exchange treatment.

International application WO 01/66478 discloses glass spacers exhibiting electronic conductivity not on the surface but within the volume. To obtain the conductivity in question, a glass of a particular composition is used: the glass matrix comprises at least 1% of oxides of transition elements that exist in a number of oxidation states.

However, it is apparent that these special glasses do not always meet the requirements of thermomechanical properties.

The Applicant has sought to remedy this drawback and to manufacture spacers capable of meeting the requirements of thermomechanical properties while still exhibiting electronic conductivity allowing them to remain invisible as a consequence of the removal of the positive or negative charges liable to build up locally (“local charging effect”, cf. page 3, lines 1 to 7 of WO 01/66478). It has discovered that it is unnecessary to use a special glass as described in WO 01/66478 in order to form the entire spacer and that it is sufficient to use this glass or a glass of the same type as a coating over all or part of the spacer, the latter being made of a material meeting the desired thermomechanical properties as far as possible.

The spacer according to the invention therefore remains invisible since the electronically conducting layer that coats it allows the aforementioned charges to be removed over a depth of less than or equal to 10 μm, equivalent to the depth of penetration of the electrons. The spacers of the invention therefore possess a core that may advantageously be made of the same glass as the substrates, the thermomechanical properties of the spacers then being similar to those of the substrates. They also make it possible for there to be a good compromise between cost and mechanical strength.

The subject of the present invention is therefore firstly a spacer for keeping a space between two substrates formed from glass sheets, more particularly a space of small thickness, generally less than a few millimeters, over the entire area of the sheet substrates, in a device such as a display screen, vacuum-type insulating glazing or a flat lamp, the surface of said spacer being at least partly electronically conducting, characterized in that said spacer is formed from a core not exhibiting electronic conductivity, the shape and the constituent material of which are chosen to provide the thermomechanical integrity of the substrates in the final device, said core being at least partly coated with at least one layer of a glass exhibiting electronic conductivity, and capable of giving the spacer electronic conductivity at 50° C. of 10⁻¹³ to 10 ohm⁻¹.cm⁻¹, preferably of 10⁻¹² to 10⁻² ohm⁻¹.cm⁻¹ and better still of 10⁻⁸ to 10⁻² ohm⁻¹.cm⁻¹.

Electronic conductivity is different from ionic conductivity, as observed in the case of conventional soda-lime glasses containing alkali metals. According to the present invention, the electronic conductivity of the core is zero or substantially zero as there may always be a residue of electronic conductivity due, for example, to iron impurities which are always present in the raw materials. Likewise, in the coating there may, for example, be a low level of alkali metals capable of migrating and thus contributing to ionic conductivity, even if its value is much less than that of the electronic conductivity.

For energy efficiency reasons, the power lost by the electronic conduction of the spacers must remain less than a fixed value; this is, for example, between 1 and 50 W/m² for microtip screens.

In particular, the glass constituting a coating layer comprises at least 1 mol %, preferably at least 5 mol %, of at least one oxide of a transition element of Groups IB, IIIB, VB, VIB, VIIB and VIII of the Periodic Table of the Elements that may exist in a number of oxidation states. As examples of such transition elements, mention may be made of V, Cr, Mn, Fe, Co, Ni, Cu, Nb, Mo, Ru, Rh, Ta, W, Re, Os, Ir, Ce, Pr, Nd, Sm, Eu, Tb, Dy, Tm and Yb. As examples of corresponding oxides, mention may be made of Fe₂O₃ and V₂O₅.

The introduction of transition elements may have an advantage other than that of giving the spacer electronic conductivity. This is because when these transition elements have a high coloring power, for example in the case of Fe and Cr, it is possible to obtain a black or dark appearance of the resulting spacer, at least as regards the section of the spacers that is seen through the substrate on which they are deposited. This black appearance may in the case of certain screens allow the spacer to be considered as a constituent element of the “black matrix”, that is to say the black matrix defining the pixels and corresponding to the area where the spacers are fixed. This is because it is then possible to fix the spacers directly to the substrates without an intermediate “bonding” material. A first possibility is then to insert the spacers into the “black matrix” in which a region has been cut out beforehand, for example by photolithography, in order to reveal an impression having dimensions barely greater than those of the spacer. This operation may suffice for fastening the spacer to the substrate. A second possibility, optionally implemented at the same time as the first one, consists in fixing the spacer to the substrate by “anodic bonding”, that is to say in applying a given electric field and a given temperature in order to establish a chemical bond between the two materials, insofar as alkali metal ions are present in the glass matrix of the core of the spacer.

According to the present invention, the glass constituting a coating layer is especially a glass having the following composition, in mol %, for a total of 100 mol %:

| | | |
|---|---|---|
| (A) | SiO₂ | 25-75 |
| (B) | at least one oxide of a | 1-30 |
| | transition element as defined above | |
| (C) | Al₂O₃ | 0-40 |
| (D) | ZrO₂ | 0-10 |
| (E) | at least one from Li₂O, Na₂O and K₂O | 0-10 |
| (F) | at least one from MgO, CaO, SrO and BaO | 0-40 |
| (H) | B₂O₃ | 0-30 |
| (I) | P₂O₅ | 0-5 |
| (J) | TiO₂ | 0-10 |
| (K) | ZnO | 0-10 |
| (M) | the usual additives | 0-1 |
| (N) | the usual impurities | complement to |
| | | 100 mol % |

(A) SiO₂ is a network-forming oxide; advantageously, its content will be less than 73% in order to reduce the melting points and prevent excessively rapid degradation of the refractories making up the furnace. Below 25%, the glass stability becomes insufficient and the risks of devitrification increase.

(C) Al₂O₃ provides the glass matrix with a stabilizing role and in particular allows the risks of devitrification to be limited, particularly for low silica contents. Advantageously, its content is less than 35%, and preferably less than 20%, so that the viscosity of the glass matrix at high temperature does not become too great.

(D) ZrO₂, unlike Al₂O₃, does not increase the viscosity of the glass matrix at high temperature. Its content does not exceed 10% and preferably 8%, in order to simplify the melting and limit the risks of devitrification.

(E) As regards the alkali metal oxides (E), these are introduced into the glass matrix essentially for the glass production conditions and more particularly for maintaining the melting point and the high-temperature viscosity within acceptable limits and for improving the uniformity of the composition during melting. Advantageously, their content is maintained below 10%, and more preferably below 5%, because of their mobility which could disturb the desired electronic conductivity.

(F) As regards the alkaline-earth metal oxides (F), these are introduced for reasons similar to those of the alkali metal oxides and, furthermore, they make it possible to improve the stability of the glass from the standpoint of the risks of devitrification. Heavy oxides, such as SrO or BaO, are especially favored in order to limit the mobility of the alkali metal ions and, as a consequence, reduce the ionic conductivity and avoid the risks of contamination of the screens, for example by alkali metal ions. It should be pointed out in fact that the diffusion of alkali metals disturbs the electronic conductivity and results in the layer undergoing an aging phenomenon when it is under a high electric field (anode/cathode potential difference), for example in FEDs.

(H) The invention also provides for the possible introduction of the oxide B₂O₃ in contents not exceeding 30% and advantageously less than 10%, in order to maintain satisfactory mechanical properties. B₂O₃ makes it possible in particular to improve the uniformity of the composition during melting and it reduces the melting point of said composition when it substitutes for SiO₂. It also makes it possible to reduce the high-temperature viscosity. According to another variant of the invention, the glass matrix is of the borosilicate type and the B₂O₃ content is then greater than 8%, and preferably greater than 10%.

(I) The oxide P₂O₅ may also be used in contents not exceeding 5%, especially in order to reduce the high-temperature viscosity.

(J)(K) The oxides TiO₂ and ZnO may also be used for reasons similar to those mentioned with regard to B₂O₃ and P₂O₅, especially in terms of regulating the melting parameters of the glass compositions.

All the oxides are selected so as to control the conductivity σ (electronic+ionic conductivity), the secondary emission coefficient δ and the dielectric characteristics ε of the spacer. This is because the three quantities σ, δ and ε affect the value of the charge and of the surface potential and therefore, for example in FEDs, the amplitude of the darkening/brightening phenomenon around the spacers. The oxides are also selected so as to limit, on the one hand, the aging phenomena, and, on the other hand, the energy losses.

(M)(N) Other additional elements may be present in the glass matrix, with contents of less than 1%. They are introduced, for example, to facilitate melting and refining (As, Sb, F, Cl, SO₃, etc.), or else they are introduced in the form of impurities in the batch materials used or in the form of impurities coming from the wear of the refractories.

The coating glass may be produced in a crucible at high temperature. The redox conditions of the glass, that is to say the respective proportions of each of the possible oxidation states of each of the cations, are controlled by controlling the relatively reducing nature of the melting atmosphere, by the temperature of the melt bath, optionally by inserting reducing agents, such as coke or the like, by a gas, into the melt bath. This redox control will especially allow the electronic conduction to be controlled so that it permits the charges to be removed while limiting the energy losses.

In accordance with the present invention, the coating may be formed from several layers, but it is preferable for a coating to have a single layer for cost reasons.

The thickness of a layer of the coating glass may vary widely: it may be from 1 to 10 000 nm, preferably from 1 to 2000 nm.

According to another feature of the spacer according to the present invention, at least one layer of at least one agent for promoting the adhesion and/or bonding of the coating to the core may have been placed between the core and the coating. As examples of these agents, mention may be made of NiCr and Al₂O₃.

The core of the spacer according to the invention may be made of a material selected from glasses, ceramics and polymers.

Glasses are preferred since, unlike polymers, a glass does not have a tendency to deform or to collapse under the effect of heat (a heat treatment is needed to seal the edges of a screen). Ceramics have good mechanical strength but, compared with a glass, it is difficult to vary their shape and also it is more expensive to produce them.

Any type of glass may be used, but preferably a glass will be selected from soda-lime glasses, aluminosilicate-type glasses and borosilicate-type glasses. The glass selected may be photosensitive, but such a selection is not particularly preferred.

Preferably, the core glass is selected so as to have thermomechanical properties similar to those of the substrates. The core of a spacer according to the invention may even very advantageously be formed from the same glass as that forming the substrates with which the spacer is intended to be used.

Thus, it may be advantageous to select a core glass having an expansion coefficient between 20 and 300° C. of between 60×10⁻⁷ and 105×10⁻⁷ K⁻¹, preferably between 60×10⁻⁷ and 95×10⁻⁷ K⁻¹, in particular between 75×10⁻⁷ and 95×10⁻⁷ K⁻¹, it being possible, however, for a glass of the borosilicate type to have an expansion coefficient of between 30×10⁻⁷ and 50×10⁻⁷ K⁻¹.

Advantageously, it is also possible to select a core glass having a temperature corresponding to the strain point high enough for it not to collapse during the step of sealing the periphery of the substrates, in particular for the purpose of forming FED screens. In general, this temperature (Tₛₜᵣₐᵢₙ) is greater than 500° C., preferably greater than 540° C.

Advantageously, the core glass also has a high elastic modulus E, for example greater than 90 GPa, preferably greater than 100 GPa, in particular greater than 130 GPa. The elastic modulus E is increased by introducing oxides (G′) into the composition of the glass—this also having the effect of increasing the density of the glass—or else by introducing nitrogen—allowing a modulus E of greater than 130 GPa to be obtained. Introduction of oxides (G′) and of nitrogen is described in greater detail below in the sections relating to (G′) and (L′) respectively.

The Applicant has demonstrated that the modulus of elasticity is the property of the spacers, especially when the latter are produced according to the process disclosed in EP-A-0 627 389, that determines the mechanical strength of the spacers when these are subjected to the pressure exerted by the flat substrates, for example forming a screen, between which a vacuum is created. Hitherto, it was common to think, as U.S. Pat. No. 5,675,212 illustrates, that the key factor determining the strength of the glass spacers for these applications was the presence of microcracks at the surface of the spacers. Thus, the Applicant has demonstrated that, in particular in the case of spacers produced according to the process described in EP-A-0 627 389, the mechanical properties of the spacer depend directly on its elastic instability and therefore on its modulus of elasticity; it interprets this phenomenon by a particularly remarkable surface state of the spacers after manufacture according to this process, without any other intervention; that is to say the spacers produced according to this process are free of defects that may result in a fracture when they are subjected to the stresses associated with their applications.

The benefit of having a high modulus E is substantial since, the mechanical strength of the core glass then being improved, it is possible to reduce the number of spacers. Consequently, the electronic conductivity and/or the thickness of the coating layer may be increased while maintaining an overall energy loss via the spacer function at an acceptable value. Another benefit is that the cost of placing the spacers is reduced.

Mention may be made of a core glass having the following composition, in mol % for a total of 100 mol %:

| | | |
|---|---|---|
| (A′) | SiO₂ | 25-75 |
| (C′) | Al₂O₃ | 0-40 |
| (D′) | ZrO₂ | 0-10 |
| (E′) | at least one from Li₂O, Na₂O and K₂O | 0-10 |
| (F′) | at least one from MgO, CaO, SrO and BaO | 0-40 |
| (G′) | at least one oxide of at least one | 0-25 |
| | from Y, La and elements of the | |
| | lanthanide series | |
| (H′) | B₂O₃ | 0-30 |
| (I′) | P₂O₅ | 0-5 |
| (J′) | TiO₂ | 0-10 |
| (K′) | ZnO | 0-10 |
| (L′) | nitrogen in combined form | 0-20 |
| (M′) | the usual additives | 0-1 |
| (N′) | the usual impurities | complement to |
| | | 100 mol % |

The various constituents (A′), (C′), (D′), (E′), (F′), (H′), (I′), (J′), (K′), (M′) and (N′) of this core glass composition have been described in more detail above with reference to the constituents (A), (C), (D), (E), (F), (H), (I), (J), (K), (M) and (N) of the glass coating, respectively. Further information useful for writing these core glass constituents and a detailed description of the constituents (G′) and (L′) are given below. Reference may also be made to WO 01/66478 for further details if necessary. It goes without saying that the proportions of (A) and (A′), (C) and (C′), etc., in the core and the coating respectively, of a spacer according to the present invention are not necessarily identical.

(A′) The SiO₂ content will preferably be less than 55% when it is desired to favor the mechanical properties, especially the modulus of elasticity. Below 25%, the stability of the glasses becomes insufficient and the risks of devitrification increase.

(C′) Above 5%, Al₂O₃ advantageously contributes to improving the mechanical properties, especially the modulus of elasticity.

(D′) ZrO₂, such as Al₂O₃, allows the strain point temperature to be increased, this being important especially in the case of spacers intended for screens that will undergo heat treatments during their manufacture.

(E′) Advantageously, the presence of the oxide Li₂O is favored when mechanical properties, especially the modulus of elasticity, are desired, it being possible, as an option, for the oxides Na₂O and K₂O to be completely absent from the matrix. On the other hand, when the economic constraints are essential, the oxide Li₂O may be absent from the matrix, this oxide being more expensive than the others. An alkali metal oxide content of at least 1% is advantageously required in order to obtain adhesion of the anodic bonding type.

(F′) The alkaline-earth metal oxides allow the strain point temperature to be increased. The oxides MgO and CaO are especially favored when a high modulus of elasticity is desired.

(G′) Introduction of at least one oxide (G′) into the glass matrix allows modulus of elasticity values of possibly up to 140 GPa to be achieved. Preferably, the sum of the contents of the oxides (G′) is greater than 1% and advantageously does not exceed 25%. The oxides (G′) are preferably selected from the following: Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃.

(H′) When a high modulus of elasticity is desired, B₂O₃ is introduced with contents of preferably less than 5%.

(I′) P₂O₅ may also be used in contents not exceeding 5%, especially in order to reduce the high-temperature viscosity without excessively degrading the mechanical properties, especially the modulus of elasticity.

(J′)(K′) The presence of TiO₂ and ZnO will be particularly favored when it is desired to obtain mechanical properties, especially a modulus of elasticity, that are enhanced.

(L′) The invention also advantageously provides for nitrogen to be introduced into the glass matrix. According to the invention, this is introduced in order to obtain moduli of elasticity of greater than 140 GPa and possibly up to 180 GPa. The nitrogen may be introduced during the melting operation, by carrying out the latter in a neutral or reducing atmosphere, for example an atmosphere of argon, nitrogen or a nitrogen-hydrogen mixture. The nitrogen is then introduced into the batch materials in the form of, for example, Si₃N₄, AlN, BN. Nitrogen also has the advantage that the spacers can be obtained with a black coloration.

(M′)(N′) Reference may be made to section (M)(N) above.

The core glass is produced in a manner known per se, like that indicated above for producing the coating glass.

The core of the spacer according to the invention may have any shape, such as a prism, in particular a right prism whose base is square, rectangular, trapezoidal, cruciform, etc., a cylinder, in particular a right cylinder of circular cross section, or a sphere.

Cores of spherical shape are not preferred as they have a tendency to roll around and subject the substrates to a high stress because of the small spacer/substrate contact area.

As particularly preferred core shapes, mention may be made of the glass polyhedra such as those described in EP-A-0 627 389 and/or manufactured by the process as described in that same document, and also all the shapes of the spacers described in WO 99/56302. The latter are described as possessing an approximately polygonal bearing cross section having at least one rectilinear bearing surface that is inscribed in a rectangle having the dimensions a and b, and the spacer rising to a height l, and their dimensions satisfying the following relationships: a<300 μm 0.2 mm<l<20 mm; and b/a<1000, and preferably b/a<200:
As examples, mention may be made of cores of the type consisting of ribs or elongate beams the drawing cross section of which is trapezoidal, the bearing surface, that is to say the surface in contact, for example, with a glass sheet, is rectangular and possesses the dimensions a and b, the height l of the spacer allowing an identical space l to be maintained between two glass sheets;
Mention may also be made of cores of the type consisting of pillars, the drawing cross section of which is of cross shape, the bearing cross section, which this time corresponds to the drawing cross section, possesses a rectangular rectilinear surface of dimensions a and b, the spacer furthermore possessing a height l.

FIGS. 3 and 4 of WO 99/56302 illustrate a beam shape and a pillar shape of cruciform cross section, respectively. These two shapes given as examples are preferred for mechanical strength reasons and also because the parts are easier to place on the substrate because of their geometry.

Mention may also be made of cores having a cylindrical shape, with a diameter of the same order of magnitude as the value a above.

The spacer according to the present invention advantageously has an electrical resistance to the flow of current of between 10⁻⁵ and 10⁷ GΩ, preferably greater than 0.1 GΩ.

Also advantageously, the spacer has a density of greater than 3, making it easier to handle and to put into place.

The spacer according to the present invention is advantageously of the type of those having the shape of pillars or of elongate beams, metal electrodes having been deposited on the sections of the pillars or the edges of the elongate beams in order to facilitate the removal of surface charges from the spacer to the electrodes placed on the substrates.

The present invention also relates to a process for manufacturing a spacer as defined above, characterized in that at least one coating glass layer is deposited on at least one part of at least one element selected from a core already manufactured or an element obtained at one stage in the manufacture of the latter, the glass used for the deposition having a composition selected so that, if this composition is modified during deposition, in the finished product it has the composition as defined above.

The core may be manufactured by the following successive operations:
drawing of a preform bar of polygonal cross section, advantageously polished on all its lateral faces;
cutting of the drawn bar into several rods;
assembly of these rods so as to be parallel to one another in such a way that they are properly held;
cutting to the desired length in order to form spacers;
optionally, polishing of the ends of the spacers all together; and
disassembling the spacers from one another, the operations of depositing the coating layer or layers being carried out on the preform bar before it is drawn and/or on the rod before it is cut to the desired length and/or on the ends of the assembled spacers and/or on the individual spacers.

The coating may thus be deposited:
either on the preform bar before it is drawn, the coating layer being drawn simultaneously with the core;
or directly on the rod (or fiber) before it is cut to the desired length; this operating procedure is beneficial;
or on the core formed after the drawing of the preform bar and cutting.

In the first two cases, only the lateral faces of the final spacer will have the coating in question; in the third case, all the faces of the spacer will be coated, optionally with the exception of one.

The process known from EP-A-0 627 389 for the manufacture of the cores will be recalled: a preform bar passes through a heating ring, which allows the glass to be drawn into rods that are assembled parallel to one another and fastened together in a suitable binder, for example a low-melting-point wax or an adhesive. It should be emphasized that, because the bar passes through the heated ring at a high temperature, the lateral faces of the rods have a “fire polish” appearance sufficient to avoid having to carry out further polishing (so as to reduce the number and the size of defects such as flakes). The rods are all cut together, optionally mechanically polished at the glass cross sections, in order to form spacers that are recovered by melting or dissolving the binder. This operating procedure allows precise dimensions to be obtained for a low cost.

In accordance with a first method of implementing the process according to the present invention, the coating layer(s) are formed by evaporation, said process comprising the steps consisting:
in depositing at least one element to be coated, placed on a support, in a vacuum chamber and in placing a refractory container, containing the glass to be deposited, in said vacuum chamber; and
in heating the refractory container to a temperature between 500 and 2000° C., while maintaining the element(s) to be coated at a lower (generally at least 20° C. lower) temperature in order to create conditions under which the glass sublimes and forms a coating layer on the surface of the element(s) to be coated.

According to a second method of implementation, the coating layer(s) are formed by sputtering, said process comprising the steps consisting:
in placing a target in a chamber containing a gas at low pressure, said target being formed from the glass to be deposited and facing at least one element to be coated;
in causing the gas contained in the chamber to ionize (formation of a plasma); and
in controlling the electrical potential of the target in such a way that gas particles bombard the target, detaching material therefrom, which material is then deposited on the element(s) to be coated.

In either of these two methods of implementation, it should be pointed out that the redox plays an important role in the properties of the coating that have an influence on the value of the surface charge, in particular on the electronic conductivity. Under certain deposition conditions, as already indicated, the redox and/or the composition of the glass from which the coating is formed may be different from those of the initial glass placed in the crucible (in the case of evaporation) or of the glass from which the target is formed (in the case of sputtering).

In accordance with particular methods of implementing the process according to the invention, before a coating glass layer is deposited, at least one layer of an agent improving the adhesion or bonding of the coating may be deposited on the elements to be coated; a heat treatment in an oxidizing or reducing atmosphere may also be applied to the coated element formed by the rod before it is cut to the desired length or formed by the final core for the purpose of adjusting the electronic conductivity and/or the secondary emission coefficient and/or the dielectric properties and/or the bonding of the coating.

A metal coating serving as electrode may be formed on the final spacer. To do this, a metal may be sputtered or evaporated, for example, using techniques that are already known, onto the preform bar before it is drawn and/or onto the individual rods and/or onto the assembled spacers and/or onto the individual spacers.

The present invention also relates to a spacer obtained by the process as defined above, to the use of the spacer as defined above or manufactured by the process as defined above as a spacer for display screens, vacuum-type glazing and flat lamps comprising at least two glass sheets; and to display screens, especially of the plasma or field emission type, in particular of the field emission display (FED) type, vacuum glazing and flat lamps comprising at least two glass sheets separated by spacers as defined above or manufactured by a process as defined above.

The following examples illustrate the present invention without however limiting its scope.

In these examples:
σ expresses the electrical conductivity of the glasses and is expressed in ohm⁻¹.cm⁻¹; this is the sum of the ionic and electronic conductivities. The conductivity of the layer is measured in the following manner. The layer is deposited on a substrate having thin electrodes. The conductivity is deduced from the measurement of the current when a known potential difference is applied between two electrodes and when the thickness of the layer, the length of the electrodes and the distance separating these electrodes have also been measured. Furthermore, the measurements were verified for temperatures varying from 50 to 100° C. The electronic conductivity is then distinguished from the ionic conductivity either by measurements at various frequencies and at various temperatures, or by observing the change in the conductivity when these specimens are subjected to a DC voltage of 100 volts and at a temperature of 100° C. In the case of an ionically conducting specimen, a rapid reduction in the conductivity as a function of time is observed. This reduction in the conductivity is due to the mobility of the ions that migrate easily in the electric field, for example Na ions. On the other hand, in the case of an electronically conducting specimen, the conductivity is approximately constant over time.
E expresses the modulus of elasticity or Young's modulus.
E was measured by four-point bending on test specimens having dimensions of 100×10×4 mm³, produced from the glasses under study. The bars, from which the test pieces were then cut, were firstly annealed for one hour at a temperature corresponding to a viscosity of 10¹³ poise and then brought back to room temperature at a rate of 2° C./min.
Tₛₜᵣₐᵢₙ (strain point) is the temperature corresponding to a viscosity of 10^{14.5} poise.
α is the expansion coefficient measured between 20 and 300° C.
d is the density of the glass.

### EXAMPLE 1

A first batch of spacer cores (SC1) having the shape described in FIG. 4 of WO 99/56302 was manufactured, starting from a preform bar, in a drawing apparatus such as that described in EP-A-0 627 389, WO 99/56302 or WO 01/66478. The glass composition of the cores SC1, expressed in molar percentages, and the corresponding values of σ, E, Tₛₜᵣₐᵢₙ, α and d are given in Table 1 below.

According to this drawing process, it is possible to maintain almost the same cross-sectional profile between the preform bar and the resulting spacer core.

After having drawn the preform bar (a=1 mm; b=21 mm) polished on all its faces in the drawing apparatus, the drawn bar was cut into several rods (a=0.1 mm; b=2.1 mm), the rods were joined together so that they were held together properly and cut to a length of 3 mm, the ends of the rods were mechanically polished all together and the rods separated from one another in order to obtain the cores SC1. This process is described in EP-A-0 627 389.

Placed in a chamber in which a vacuum could be created, were, on the one hand, cores SC1 arranged on a specimen holder or support and, on the other hand, a molybdenum crucible containing the coating glass CG to be deposited on the cores SC1.

The composition of the glass CG was the following, in mol %:

| | |
|---|---|
| SiO₂ | 63.3 |
| Fe₂O₃ | 11.5 |
| V₂O₅ | 1.5 |
| Al₂O₃ | 0.2 |
| Na₂O | 2.7 |
| SrO | 6.0 |
| BaO | 14.8 |
| | 100 |

The glass CG had the following properties:
σ to 50° C. (ohm⁻¹.cm⁻¹): 8×10⁻¹¹
E (GPa): 81
Tₛₜᵣₐᵢₙ (° C.): 548
α (10⁻⁷ K⁻¹): 81
d: 3.51.

An absolute pressure of about 10⁻⁶ mbar was established in the chamber and a 200 nm thick layer of the glass CG was deposited at a rate of 1 nm/s. During the deposition step, the specimen holder, on which the cores SC1 were held, was rotated so as to obtain a layer of uniform thickness on all the faces of the cores.

### EXAMPLES 2 AND 3

Example 1 was repeated, replacing the core glass SC1 with core glasses SC2 and SC3 respectively, the compositions and the σ, E, Tₛₜᵣₐᵢₙ, α and d values of which are given in Table 1.

The glass CGc forming the surface layer of the spacers according to Examples 1 to 3 were analyzed by SIMS. Its composition was the following, in mol %:

| | |
|---|---|
| SiO₂ | 66.3 |
| Fe₂O₃ | 26.5 |
| V₂O₅ | 3.3 |
| Al₂O₃ | 0.1 |
| Na₂O | 2.2 |
| SrO | 0.1 |
| BaO | 1.5 |
| | 100 |

Compared with the glass CG, the glass CGc was enriched with oxides of the transition elements Fe and V, which contribute to improving the electronic conductivity.

The glass CGc had an electrical conductivity a of 3×10⁻⁷ ohm⁻¹.cm⁻¹ measured at 20° C. This value is very much greater than the a value of 8×10⁻¹² ohm⁻¹.cm⁻¹ obtained for the glass CG measured under the same conditions. A melting test showed that the glass CGc was not fusible: it is believed that this is due to the low content of oxides of the alkaline-earth metals Na, Sr and Ba, which act as fluxing agents.

Depositing the coating glass on the cores by evaporation is particularly advantageous as it makes it possible to achieve an electronic conductivity level higher than that of the starting glass, and also to form a glass layer that is nonfusible in bulk.

FED-type screens formed with the spacers of Examples 1 to 3 and substrates made of the glass SC1 exhibited no darkening/brightening phenomena, nor any aging, near the spacers. The mechanical integrity of the screen was satisfactory, particularly during the step of sealing the edges.

TABLE 1

| | | SC1 | SC2 | SC3 |
|---|---|---|---|---|
| Composition | | | | |
| (A′) | SiO₂ | 73.0 | 52 | 71.7 |
| (C′) | Al₂O₃ | 0.4 | 14 | 0.3 |
| (D′) | ZrO₂ | 2.1 | | |
| (E′) | LiO₂ | | 5 | |
| | NaO₂ | 4.7 | | 12.6 |
| | K₂O | 3.9 | | |
| (F′) | MgO | 0.2 | 15 | 6.1 |
| | CaO | 11.3 | | 9.3 |
| | SrO | 4.4 | | |
| (H′) | ZnO | | 2 | |
| (G′) | Y₂O₃ | | 2 | |
| | La₂O₃ | | 10 | |

| | | | |
|---|---|---|---|
| Properties | | | |
| σ (ohm⁻¹ · cm⁻¹), at 50° C. | 3 × 10⁻¹⁷ | | 3 × 10⁻¹² |
| E (GPa) | 77 | 107 | 73 |
| Tₛₜᵣₐᵢₙ (° C.) | 587 | | 507 |
| α (10⁻⁷ K⁻¹) | 79 | 63 | 84 |
| Density | 2.64 | 3.56 | 2.50 |

1. A spacer comprising
a core which does not exhibit electronic conductivity and
at least one coating comprising at least one layer of a glass exhibiting electronic conductivity coated on said core, wherein the glass is capable of providing the spacer an electronic conductivity at 50° C. of 10⁻¹³ to 10 ohm⁻¹.cm⁻¹,
wherein said spacer is capable of maintaining a space between two substrates formed from glass sheets, over the entire area of the sheet substrates, in a device
the surface of said spacer is at least partly electronically conducting, and
the shape and the constituent material of the spacer provide thermomechanical integrity of the substrates in the device.

2. The spacer as claimed in claim 1, wherein the spacer has an electronic conductivity of 10⁻¹² to 10⁻² ohm⁻¹.cm⁻¹.

3. The spacer as claimed in claim 1, wherein the glass comprised in said coating comprises at least 1 mol %, of at least one oxide of a transition element of Groups IB, IIIB, VB, VIB, VIIB and VIII of the Periodic Table of the Elements that optionally exist in a number of oxidation states.

4. The spacer as claimed in claim 3, wherein the transition element(s) are at least one selected from the group consisting of V, Cr, Mn, Fe, Co, Ni, Cu, Nb, Mo, Ru, Rh, Ta, W, Re, Os, Ir, Ce, Pr, Nd, Sm, Eu, Th, Dy, Tm and Yb.

5. The spacer as claimed in claim 1, wherein the glass comprised in said coating is a glass having the following composition, in mol %, for a total of 100 mol %:

| | | |
|---|---|---|
| (A) | Si0₂ | 25-75 |
| (B) | at least one oxide of a | 1-30 |
| | transition element of Groups IB, IIIB, VB, VIB, | |
| | VIIB and VIII of the Periodic Table of the | |
| | Elements that optionally exist in a number | |
| | of oxidation states | |
| (C) | Al₂O₃ | 0-40 |
| (D) | Zr0₂ | 0-10 |
| (E) | at least one material selected from the group | 0-10 |
| | consisting of Li₂O, Na₂O and K₂O | |
| (F) | at least one material selected from the group | 0-40 |
| | consisting of MgO, CaO, SrO and BaO | |
| (H) | B₂O₃ | 0-30 |
| (I) | P₂O₅ | 0-5 |
| (J) | TiO₂ | 0-10 |
| (K) | ZnO | 0-10 |
| (M) | additives | 0-1 |
| (N) | impurities | complement to |
| | | 100 mol %. |

6. The spacer as claimed in claim 1, wherein the coating consists of one layer.

7. The spacer as claimed in claim 1, wherein each layer of the coating has a thickness from 1 to 10,000 nm.

8. The spacer as claimed in claim 1, wherein the spacer further comprises at least one layer of at least one agent to promote the adhesion and/or bonding of the coating to the core between the core and the coating.

9. The spacer as claimed in claim 1, wherein the core comprises a material selected from the group consisting of glasses, ceramics and polymers, wherein said core optionally comprises the same glass as that comprised in the substrates.

10. The spacer as claimed in claim 9, wherein the core comprises a glass having an expansion coefficient between 20 and 300° C. of between 60×10⁻⁷ and 105×10⁻⁷ K⁻¹, wherein the core optionally comprises a glass of the borosilicate type having an expansion coefficient of between 30×10⁻⁷ and 50×10⁻⁷ K⁻¹.

11. The spacer as claimed in claim 1, wherein the core comprises a glass having a temperature corresponding to the strain point of greater than 500° C.

12. The spacer as claimed in claim 1, wherein the core comprises a glass having an elastic modulus greater than 90 GPa.

13. The spacer as claimed in claim 1, wherein the core comprises a glass having the following composition, in mol % for a total of 100 mol %

| | | |
|---|---|---|
| (A′) | Si0₂ | 25-75 |
| (C′) | Al₂O₃ | 0-40 |
| (D′) | ZrO₂ | 0-10 |
| (E′) | at least one material selected from the group | 0-10 |
| | consisting of Li₂O, Na₂O and K₂O | |
| (F′) | at least one material selected from the group | 0-40 |
| | consisting of MgO, CaO, SrO and of Li₂O, | |
| | Na₂O and BaO | |
| (G′) | at least one oxide of at least one element selected | 0-25 |
| | from the group consisting of Y, La and | |
| | elements of the lanthanide series | |
| (H′) | B₂O₃ | 0-30 |
| (I′) | P₂O₅ | 0-5 |
| (J′) | TiO₂ | 0-10 |
| (K′) | ZnO | 0-10 |
| (L′) | nitrogen in combined form | 0-20 |
| (M′) | additives | 0-1 |
| (N′) | impurities | complement to |
| | | 100 mol %. |

14. The spacer as claimed in claim 1, wherein the core has a prismatic shape.

15. The spacer as claimed in claim 1, wherein the spacer has an electrical resistance to the flow of current of between 10⁻⁵ and 10⁷ GΩ.

16. The spacer as claimed in claim 1, wherein the spacer has a density of greater than 3.

17. The spacer as claimed in claim 1, wherein the spacer is black or dark in color.

18. The spacer as claimed in claim 14, wherein the spacer is in the shape of pillars or of elongate beams,
wherein the pillars or the edges of the elongate beams comprise metal electrodes deposited on the sections of the pillars or the edges of the elongate beams to facilitate the removal of surface charges from the spacer to the electrodes.

19. A process for manufacturing a spacer as claimed in claim 1, the process comprising:
depositing at least one coating comprising at least one layer of glass on at least one part of at least one element comprised in a pre-manufactured core or an element obtained at one stage in the manufacture of said core, wherein the composition of the glass, if modified during said deposition, is selected to obtain a composition in the manufactured spacer to be the same as the composition of the glass comprised in the spacer as claimed in claim 1.

20. The process as claimed in claim 19, wherein the core is manufactured by the process comprising:
drawing a preform bar of polygonal cross section,
cutting the drawn bar into several rods;
assembling said rods to be parallel to one another to be properly held to obtain assembled rods;
cutting the assembled rods to the desired length to form assembled spacers;
optionally, polishing the ends of the assembled spacers all together; and
disassembling the assembled spacers from one another to form individual spacers, wherein said depositing the coating is carried out
on the preform bar before said drawing and/or
on the rod before said cutting to the desired length and/or
on the ends of the assembled spacers and/or
on the individual spacers.

21. The process as claimed in claim 19, wherein the coating is formed by a process comprising:
depositing at least one element to be coated, placed on a support, in a vacuum chamber and placing a refractory container, comprising the glass to be deposited, in said vacuum chamber; and
heating the refractory container to a temperature between 500 and 2000° C., while maintaining the element(s) to be coated at a lower temperature in order to create conditions under which the glass sublimes and forms a coating layer on the surface of the element(s) to be coated.

22. The process as claimed in claim 19, wherein the at least one coating is formed by a process comprising:
placing a target in a chamber comprising a gas at low pressure, said target being formed from the glass to be deposited and facing at least one element to be coated;
causing the gas comprised in the chamber to ionize; and
controlling the electrical potential of the target so that gas particles bombard the target, detaching material therefrom, wherein said material is then deposited on the element(s) to be coated.

23. The process as claimed in claim 19, further comprising before said depositing at least one coating, depositing at least one layer of an agent to improve the adhesion or bonding of the coating on the elements to be coated.

24. The process as claimed in claim 20, further comprising applying a heat treatment in an oxidizing or reducing atmosphere to the coated element formed by the rod before said cutting to the desired length or formed by the final core to adjust the electronic conductivity and/or the secondary emission coefficient and/or the dielectric properties and/or the bonding of the coating.

25. A spacer obtained by the process as claimed in claim 19.

26. The spacer as claimed in claim 1, wherein the device is a display screen, a vacuum glazing and a flat lamp comprising at least two glass sheets.

27. A display screen, vacuum glazing and flat lamp comprising at least two glass sheets separated by spacers as claimed in claim 1.
